(19) United States
(12) Patent Application Publication
(10) Pub. No.: US 2013/0139889 A1
(43) Pub. Date: Jun. 6, 2013

(54) SELF POWERED AND AUTOMATED ATTACHMENT TO A WATER SYSTEM

(71) Applicant: Livne Manes Gan, Omer (IL)

(72) Inventor: Livne Manes Gan, Omer (IL)

(21) Appl. No.: 13/310,820

(22) Filed: Dec. 5, 2011

(51) Int. Cl. F16K 31/02

(52) U.S. Cl. 137/1; 251/129.01

(57) ABSTRACT

Embodiments of the present invention relate to an attachment mechanism adapted to be attached to fluid system having a hydroelectric generator adapted to convert a flow of a fluid through the fluid system into electrical power. The attachment mechanism further includes a control unit coupled to the hydroelectric generator, capacitor to store the electrical power generated by the hydroelectric generator, and a motor coupled to the control unit. In addition, the attachment system includes a pinch valve coupled to the motor, such that the control unit is adapted to automatically control the motor for actuating the pinch valve for regulating the fluid flow within the fluid system. The attachment mechanism further includes sensor unit to detect the condition in vicinity to the attachment mechanism. As further disclosed herein, the control unit is powered by the flow of the fluid through the fluid system.

### BACKGROUND

1. Technical Field

The present invention generally relates to fluid systems, more particularly to a self powered and automated mechanism attachable to a fluid, i.e., water system.

2. Discussion of the Related Art

Recent growing awareness to the environment and conservations of natural resources, such as water and energy, have lead to the development and spread of alternative technologies and methods for minimizing harm to the environment while maximizing production of energy for wide use. Indeed, methods used in renewable energies and other green technologies have taken center stage in the last decade or so for addressing the growing need throughout the globe for conserving natural resources. Particularly, such technologies include hydroelectric power produced and harnessed mainly through the large scale use of dams and wind turbine farms, most of which require a substantial logistical infrastructure and the availability of large areas of land.

Nevertheless, with growing populations, the wide use of energy and water, as well as the growing need for conserving resources appears to currently outweigh the pace at which conservation methods are developing. For example, water, as a natural resource and as a fundamental necessity, is obliviously consumed by every society to the extent it is consumed without paying any attention to the quantity or the frequency of its use. Undoubtedly, the over use of water in certain settings such as homes, offices, industrial institutions, gardens, public institutions and other facilities may typically be due to a lack of judgment, absent mindedness or otherwise to the inability of monitoring and/or regulation of its use. Accordingly, without alleviating such shortcomings, continued waste of water and similar resources is likely to grow, thereby leading to unnecessary waste of valuable resources.

### BRIEF SUMMARY

Exemplary embodiments of the present invention disclose a system adapted to be attached to a water system, such as spout of a faucet, sprinklers, water irrigation systems and/or other water flow and supply systems, whereby the attachable system can automatically control the flow of water of the system to which the attachment is coupled. More specifically, the disclosed attachment system includes, a hydroelectric mechanism adapted for producing and storing energy gained from the water flowing through the faucet. In addition, the attachment to the water system uses hydroelectricity obtained from water flowing through the to activate a sensor located on or in close proximity to the attachment, whereby the sensor is adapted to sense the presence of an object, i.e., user's hand, thereby controlling the flow of water through the water system. Thus, in a preferred embodiment, the sensor may initiate or terminate the flow of water. Further, the disclosed attachment is not limited to be used only with water and is adaptable for use with other substances in the liquid state.

Other aspects of the invention may include a system arranged to execute the aforementioned method. These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a perspective view of a water system, in accordance with an exemplary embodiment of the present technique.

FIG. 2 is a side view of an attachment to water system, in accordance with and exemplary embodiment of the present technique.

FIG. 3 is a side view of a hydroelectric mechanism, in accordance with an exemplary embodiment of the present technique.

FIG. 4 is a block diagram of a hydroelectric system, in accordance with an embodiment of the present technique.

FIG. 5 is a perspective view of a hydroelectric system, in accordance with an embodiment of the present technique.

FIG. 6 is a bottom perspective view of the hydroelectric system shown in FIG. 5, in accordance with an embodiment of the present technique.

FIG. 7 is another perspective view of the hydroelectric system shown in FIGS. 5 and 6.

FIG. 8 is yet another perspective view of the hydroelectric system shown in FIGS. 5-7.

### DETAILED DESCRIPTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

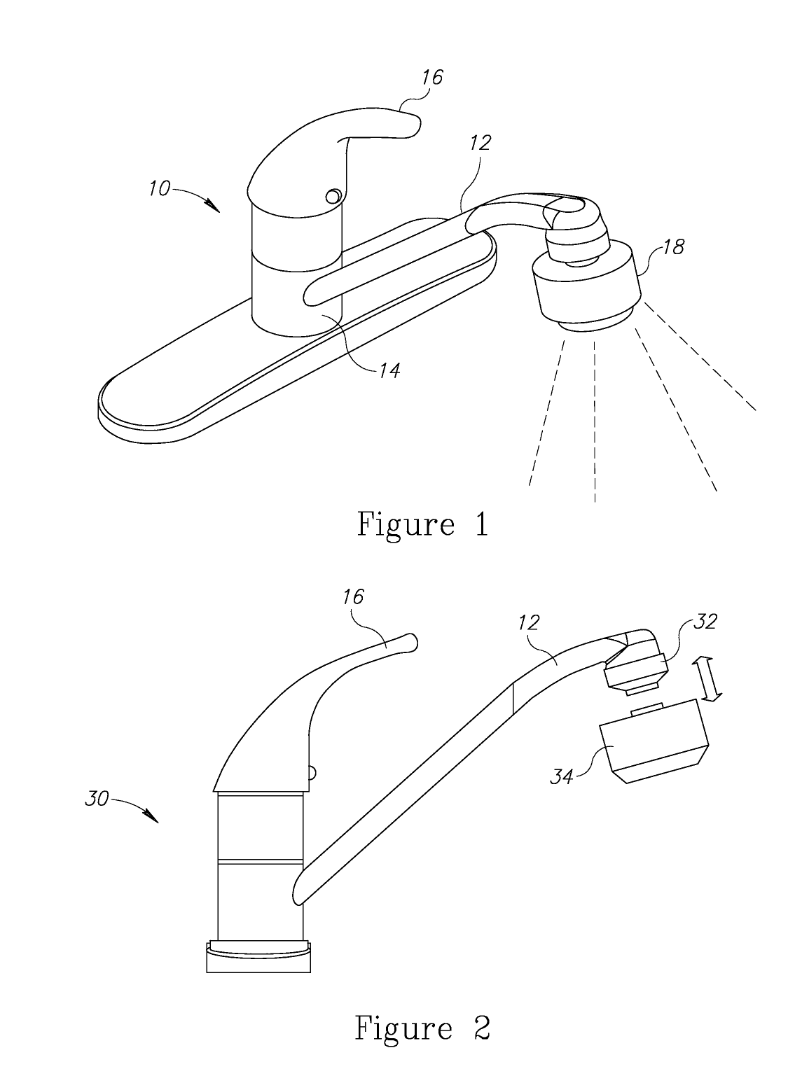

Turning to the figures, FIG. 1 is a perspective view of a hydroelectric water system 10, i.e., faucet, in accordance with an exemplary embodiment of the present technique. Although the faucet 10 depicted by the FIG. 1 may resemble one generally used in homes, offices, restaurants and the like, those skilled in the art will appreciate that the present technique may be applicable to a variety of faucets, liquid outlets, and or other liquid delivering devices. It may further be appreciated that the present technique can be applied to the delivery and use of various types of liquids, including but not limited to water, oil, gasoline, jet fuel, and the like.

Accordingly, the hydroelectric faucet 10 includes a water outlet/spout 12 coupled to a base 14. Further, on top of the base 14, there is disposed a handle 16, generally adapted for manual operation of the faucet 10. As further depicted by FIG. 1, at the tip of the water extension outlet 12, there is disposed an attachable hydroelectric mechanism 18, adapted to be attached to the spout 12, and further adapted for automatically controlling the flow of water through the outlet 18 and faucet 10 in general.

As will be described further below, in exemplary embodiment, the hydroelectric mechanism 18 may include a miniature hydroelectric generator having a miniature turbine actuated by water flowing through water extension outlet 12 and, ultimately, through the mechanism 18. As will be shown further below, the illustrated embodiment takes advantage of the flowing water produced by water pressure ranging between 2-6 atmospheres as the water attains sufficient kinetic energy for rotating a turbine, also part of the aforementioned hydroelectric generator. As appreciated by those skilled in the art, such a generator can include a turbine having hydrodynamic design for efficiently rotating a stator, magnet or similar device (not shown) for yielding storable energy. Hence, such energy can be stored, for example, by a capacitor, from which such energy can be used for operating the water system. In addition, the capacitor can also harness the energy for an indefinite amount of time so that it may be retrieved in the future for further use. As will be further shown and discussed below, the aforementioned mechanism 18 may further include a sensor for generally detecting the presence of an object located near or in the vicinity of the facet 10. Thus, when detecting such a presence, the sensor can be used to provide feedback signals to a control unit for actuating a valve that could, for example, initiate or terminate the flow of water through the faucet 10. Thus, the senor, the control unit and/or the valve may be functionally powered through the hydroelectric energy obtained by the faucet 10 and the system 18.

As shown in a water system 30 is fitted with a hydroelectric system 34 adapted for converting water flowing though the outlet 12 and tip 32 into electrical power. As described above, such hydroelectric power obtained by a hydroelectric generator disposed within the system 34 can be used mainly for operating a sensor adapted to provide feedback signals to a control unit for controlling the operation of the water system 30. Thus, the sensor, valve, motor and the control unit disposed within the unit 34 draw their operating energy from the hydroelectric power provided by the water flowing through the hydroelectric system 34.

Accordingly, while the attachment system 34 is similar the hydroelectric system 18, described by FIG. 1, the system 34 is an independent unit that is separable from the faucet 30. Hence, the system 34 can be fitted onto the tip 32 of system 30 so that it can operate as an integral part of the system 30. In fact, the attachment system 34 can be adapted in a manner that would enable a retrofitting of the system 34 onto wide variety of faucets and/or similar water outlets. Such retrofitting could be achieved by having screwing, clamping, or otherwise pressurizing the hydroelectric system onto the spout 32 of water system 30.

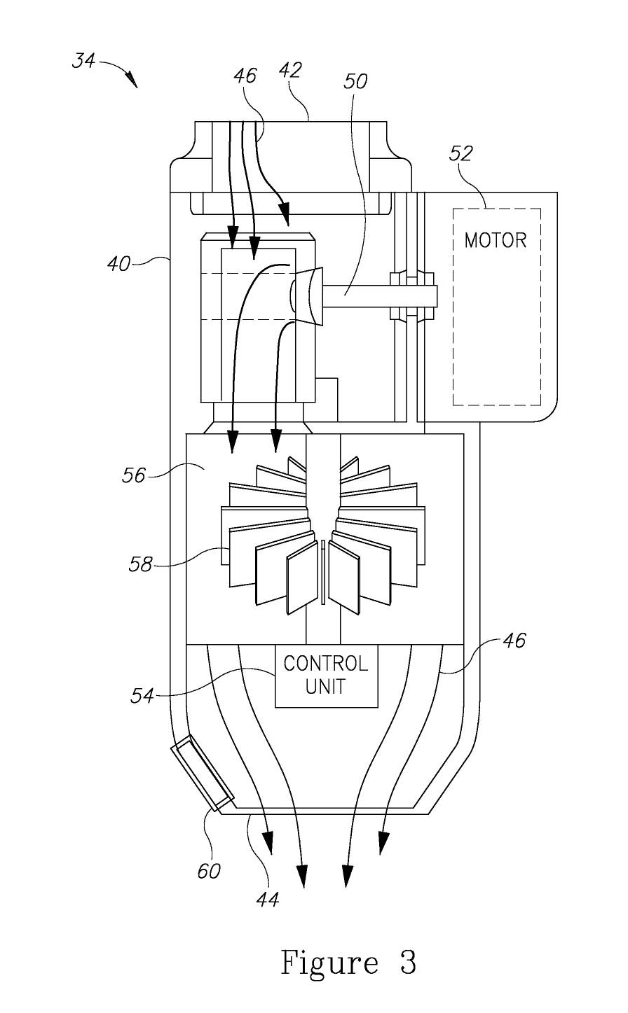

Turning now to FIG. 3, the hydroelectric mechanism 34 is depicted, in accordance with an exemplary embodiment of the present technique. The hydroelectric mechanism 34 includes a casing 40 adapted for housing multiple internal units as described further below. The casing 40 also includes openings 42 and 44, whereby the opening 42 is adapted to be affixed to or incorporated with a water outlet, such as those shown by FIGS. 1 and 2 described herein. As shown by water flow arrows 46, the opening 42 is further adapted to receive incoming water from the faucet tip, i.e., water tips 18 or 32, for enabling the water 46 to traverse through the system 34 and out the opening 44.

As further depicted by FIG. 3, the hydroelectric system 34 also includes a valve 50 coupled to a motor 52. Accordingly, the valve 50 is actuated by the motor 52 for opening or closing the water way extending from the opening 42 to the cap 50. As shown below, the motor 52 operates in response to signals received from control unit 52, also disposed within casing 40, for actuating the valve 50 to open or close the attachment system 34 to the flow of the water 46. Further, the hydroelectric system 34 includes a miniature hydroelectric generator 56 disposed beneath the valve 50. The hydrogenerator 56 further includes a turbine, typically made up of rotating blades 58, adapted to receive the water 46 is flow from the top opening 42 down the casing 40 of the system 34. Those skilled in the art will appreciate that various turbine and blade designs may be fabricated so that sufficient rotational speed of the blades 58 may be achieved for producing a suitable amount of energy which can further be harnessed and used when needed. In one exemplary embodiment, water pressure ranging between 2-6 atmospheres may be sufficient enough for producing the desired liquid flow to attain the needed electrical power for operating the system 34. Nonetheless, the present technique may be extended to include hydroelectric generators and turbines having other designs that could make use of varying liquid pressure, some of which may be higher or lower than those mentioned above. Further, although not shown, the hydroelectric generator 56 may further include a miniature or a small rotating stator and/or a small magnet for enabling the production of electrical energy resulting from the mechanical rotational energy obtained by the blades 58 as they rotate. It should further be borne in mind that while the illustrated mechanism 34 in general and, the hydroelectric generator 56 in particular, mainly exploit the gravitational fall of the water to produce energy, the aforementioned systems can also be used to exploit liquid flow produced via pressure changes occurring along a pipe or other water delivery pathways experiencing pressure changes, some of which may be caused by artificial means, such as pumps and the like. The hydroelectric generator 56 may further be built using different technique, such as using piezoelectric mechanism to produce electrical power prom the water flow throughout the hydroelectric system 34.

The hydroelectric system 34 further includes a sensor 60 disposed at the bottom of the housing 40 and close to the bottom opening 44. The sensor 60 may be a general sensor, such as an infrared sensor, CMOS sensor, image sensor, pressure sensor, touch sensor, electrostatic sensor and/or any similar device, as appreciated by those skilled in the art. The sensor 60 may be arrange in one to 4 different sensor unit around the hydroelectric system 34. The sensor 60 is adapted to detect the presence of an object, or lack thereof, and provide corresponding signals to the control unit 54 for closing or opening the valve 50, thereby controlling the flow of water through the system 34 and the faucet, i.e., faucets 18 and 30 of the above FIGS. 1 and 2, to which the system 34 is attached.

Accordingly, the control unit 54 may be made up of a processing device, such as an FPGA, microcontroller and/or other solid state devices, adapted for executing certain algorithms based on reception of electrical signals from the sensor 60. The control unit may further employ such algorithms for providing signals to the motor 52 in actuating the valve 50 thereby controlling the flow of water 46 through the device 34 and the faucet to which it is affixed. It should be born in mind that the motor 52 control unit 54 and sensor 60 may all be powered by the electricity stored in the capacitor obtained through the operation of the hydroelectric generator 56. Those skilled in the art will appreciate that the electrical energy obtained from the hydroelectric generator can be harnessed using a capacitor and that such energy can be retrieved at any point in time from the capacitor.

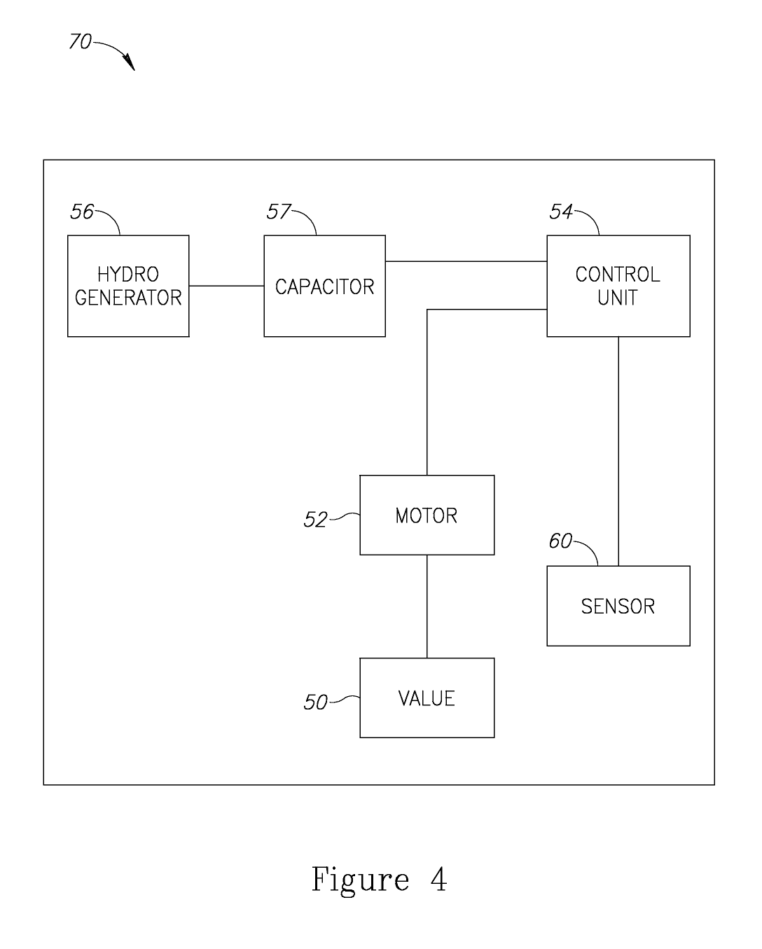

FIG. 4 is a block diagram of a hydroelectric system, in accordance with an embodiment of the present technique. Accordingly, block diagram 70 is a functional depiction of the above described components included within a hydroelectric system, such the system 34 depicted by FIG. 3. It should be borne in mind that functional components illustrated by block diagram 70 are only exemplary and that other components and implementations can be realized by a hydroelectric system similar the system 34 described above.

Thus, as illustrated by diagram 70, in a preferred embodiment the hydroelectric generator 56 is coupled to capacitor 57. In turn, the hydroelectric generator is then coupled to a control unit 54, further coupled to sensor 60 and motor 52. Accordingly, the motor 52 is also coupled to the valve 50. Hence, in a preferred embodiment, the hydroelectric generator provides hydroelectric power to capacitor 57 which, in turn, stores and provides the power to the control unit 54. As further illustrated, the control unit 54 distributes the power to the motor 52 and sensor 60, respectively. Thus, it should be born in mind that the connections by the various components, as depicted by the diagram 70, may include transfer of mechanical and data signals between mechanically and electrically operating components, respectively, as well as transfer of power signals, all of which originate from the hydroelectric generator 56. Thus, power to the other components shown by the diagram 70 may be provided directly by the aforementioned energy storing devices.

Accordingly, during operation, a user wishing to open a faucet, such as the water system 10 of FIG. 1 may place a hand or other object close to the sensor 60. In so doing, the senor may detect the presence of the user and, consequently, provide an electrical signal to the control 54. The control 54 intakes such a signal and perform certain processing to provide an output to motor 52 which, in turn, actuates the valve 50 for opening the hydroelectric system 18 and enabling to flow through the hydroelectric system 34. Upon removal of the user's hand or upon a sensing, as performed by the sensor 60, that the user is no longer in the vicinity of the faucet, the control unit 54 may instruct the motor 52 to actuate the valve once more, so as to close the hydroelectric system 34 and cease the water flow.

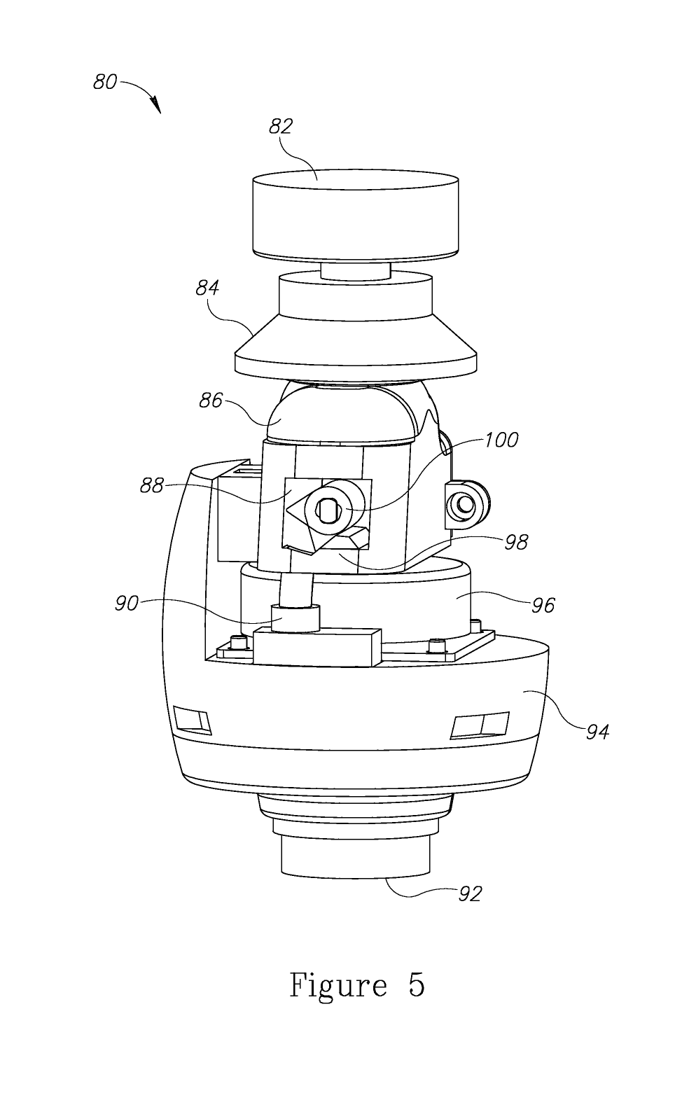

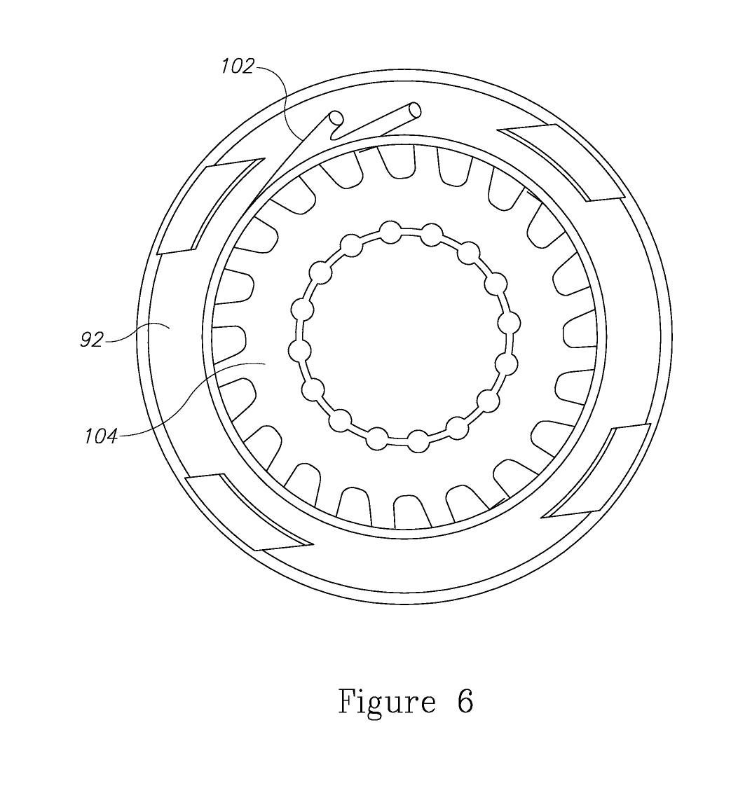

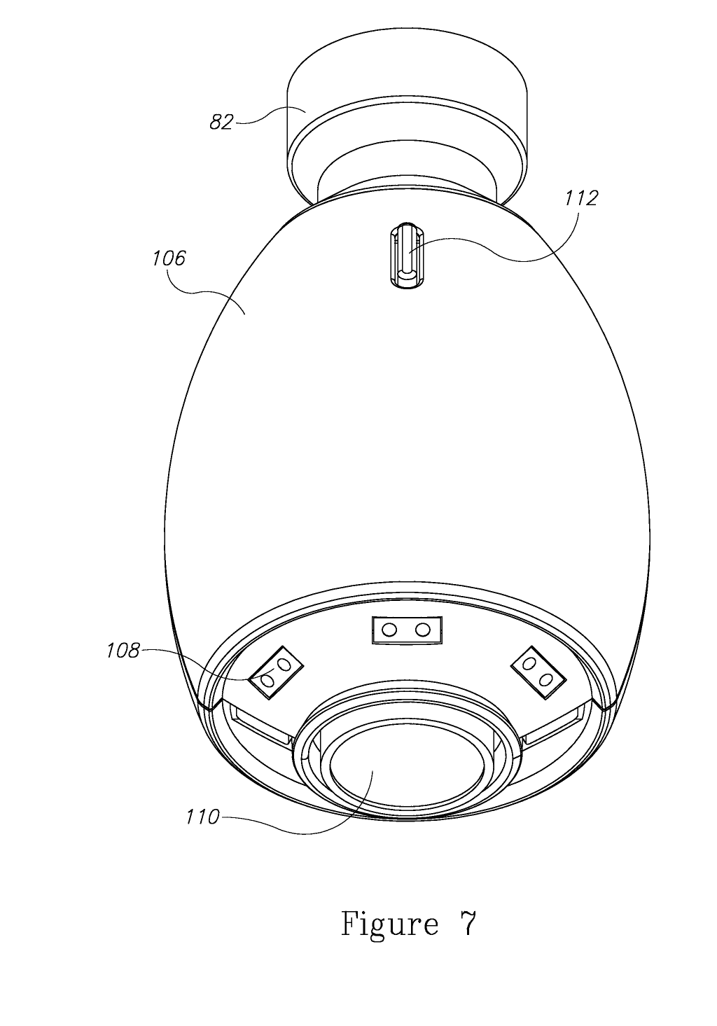

FIGS. 5-8 illustrate various perspective views of a hydroelectric system 80 in accordance with an embodiment of the present technique. Particularly, FIG. 6 is a bottom perspective view of the system 80, showing additional features of the hydroelectric system, in accordance with an embodiment of the present technique. The system 80 is a hydroelectric system incorporated within the above discussed and illustrated systems attachable to a water system, such as the hydroelectric system 10 of FIG. 1. The system 80 is made up of various components adapted to intake a fluid, i.e., water, whereby the fluid can be delivered through various components, such as those adapted to utilize motion of the fluid for generating hydroelectric power. Accordingly, the system 80 includes an opening 82 adapted to intake water flowing from a faucet, or other piping to which the system 80 is coupled. The intake 82 is coupled to an adjustable connector 84 adapted to sway the system 80 through various angles for positioning the system 80 into various desirable positions, as may occur when the system 80 is coupled to the faucet 12. In other words, the adjustable connector 84 can be used by a user to direct the flow of water of the faucet and the attachment (e.g., attachment 34, FIG. 1) at various angles.

The system 80 further includes a tube casing 86 connecting the members 82 and 84 to tube 88, through which the incoming water flows to turn a turbine wheel and which eventually exits through outlet 92, as further shown in FIG. 6. Further, the casing 86 is also adapted to house a motor (not shown), such as the motor 52, illustrated in FIG. 3. Accordingly, the motor 52 is adapted to actuate a pinch valve 100 disposed adjacent to casing 86. As illustrated, the pinch valve 100 is formed of a rotatable member disposed on an axis, enabling the valve 100 to be rotated through one or more angels. In so doing, the pinch valve 100 can be controlled to apply pressure to the tube 88 for blocking and/or opening the tube 88 to fluid flow. In so doing, the pinch valve 100 is adapted to control fluid flow through the system 80. As illustrated, the tube 88 extends through a passage to connector 90, such that the pinch valve can compress or otherwise bring about the expansion of the tube 88 for controlling water flow through the system 80. Advantageously, the pinch valve 100 is adapted to come in contact with only the tube 88 such that the valve 100 does not directly contact the fluid itself as it flows through the system 80. Hence, such a system enables a more clean and sterile control of the fluid flow, one which minimizes contaminations to the fluid or, alternatively, minimizes any corrosion or degrading effects caused to the various portions of the system 80 as a result of contact made by the fluid and the system 80. In addition, by not making direct contact with the fluid passing through tube 88, the use of the pinch valve in accordance with the present technique further enables using the system 80 with a variety liquids having varying degrees of chemical concentration, salinity, acidity, mineral levels, viscosity, and/or other properties.

Furthermore, the pinch valve 100 can be controlled via the motor 52 to apply various degrees of pressure to regulate the amount of fluid that passes through the fluid. In turn, this operation may also control the motion of the turbine wheel 104 (FIG. 6) in generating hydroelectric power used for powering sensors or other devices to which the system 80 may be coupled. As further illustrated, a stopper 98 is adjacent to pinch valve 100. Accordingly, the stopper 98 may be adjusted in length so that during operation, the valve 100 does not over extend and is proper brought to a stop by the stopper 98. Hence, such operation of the stopper 98 may minimize any unwanted or excessive movement of the valve 100 so as to minimize or otherwise eliminate any damages to the system that could be caused by an overextension of the valve 100. As further illustrated, the illustrated stopper 98 provides a mechanical mechanism for controlling the movement of the valve 100. In addition, such mechanical set up obviates the need for using any elaborate electrical or other electro-mechanical device for controlling the movement of the valve 100.

Further illustrated is a hydroelectric generator 96 fitted and disposed directly beneath the casing 86 and above base member 94. In this configuration the system 80 provides a small and compact hydroelectric system that can be fitted within an attachable system, i.e., system 34, adapted to be attached to a faucet. Hence, the system 80 utilizes the water flowing therethrough for operating the hydroelectric systems incorporated therein for producing power. Such power may be used for actuating certain valves, i.e., pinch valve 100, as well as other sensing devices, i.e., sensor 60, also adapted to control the fluid flow. Further, the valve 100 may be continuously controlled either through the motor 52, or control unit 54 for varying the amount of water flowing through the system 80. It should be borne in mind that control of the fluids systems, as disclosed herein is adapted to perform various operations and functionalities. For example the control unit 54 includes a user interface enabling adjustment of sensitivity of the sensor 60 coupled thereto. The control unit may further have a user interface adapted to sense fluid temperature and provide indication of the temperature via a colored light emitting diode (LED). By further example, the control unit has user interface that enables manual operation of a pinch valve. Further, the control unit has a user interface that enables final positioning of the pinch valve for regulating the fluid flow. The control unit has a user interface that enable sensing energy accumulated on the capacitor resulting from the operation of the hydrogenerator. The interface further provides indicating the amount of energy utilizing a colored LED. The control unit further includes an interface and sensing mechanisms adapted to provide an indication of fluid pressure sustained with the above attachment fluid system.

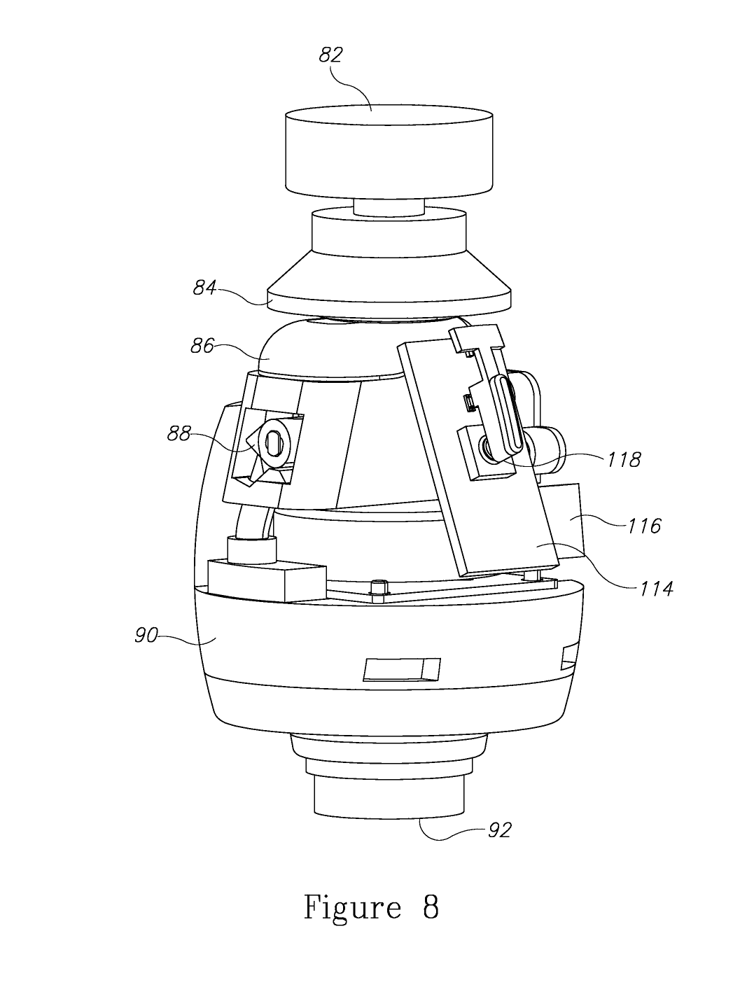

As further illustrated by FIGS. 6, the hydroelectric system 80 includes a turbine housing 94 in which turbine 104 is housed. There is also illustrated water outlets 102 adapted to output the out flowing liquid as it impinges the turbine 104. In so doing, the exiting fluid rotates the turbine 104 as sufficiently rates so that its mechanical rotational energy transform to electrical energy, as performed by the above hydroelectric generator. Those skilled in the art that the turbine may be formed of different materials and have various shapes and sizes in accordance with various known standards and specifications for providing optimal rotational speeds for yielding a desirable output power. As further illustrated by FIG. 7, the system 80 includes a protective shell 106, as well as, one more sensor unit 108. The sensor units are adapted to detect a presence of an object which can prompt the actuation of the system 80 to provide water out the outlet 92. As further illustrated by FIGS. 7 and 8, a push button guide 112 is disposed on shell 106. The guide 112 enables manual actuation of the valve, and some interface to change the sensor detection range and threshold. The guide 112 is also adapted to interface with the control unit.

Adjacent to the guide 112 there is disposed an electrical board 114 of the control unit, having various electrical components adapted for controlling the operation of the hydroelectric system 80. As further illustrated by FIG. 8, a capacitor 116 is disposed on or near board 114. Hence, the capacitor 116 is adapted to harness any electrical power resulting from the operation of the turbine wheel 104. On top of the board 114 there is also disposed a push button tactile switch 118, which is part of the control unit.

What is claimed is:

1. An attachment mechanism to a fluid system, comprising:
a hydroelectric generator adapted to convert a flow of a fluid through the fluid system into electrical power;
electrical storage unit adapted to store the electrical power generated by the hydroelectric generator;
a control unit coupled to the electrical storage unit;
a motor coupled to the control unit;
a pinch valve coupled to the motor;
at least one sensor unit coupled to the control unit;
wherein the control unit is adapted to automatically control the motor to actuate the pinch valve for regulating the fluid flow within the fluid system by the sensor unit output, and wherein the control unit is powered by the flow of the fluid through the fluid system.

2. The mechanism of claim 1, wherein the fluid comprises water.

3. The mechanism of claim 1, wherein movement of the pinch valve is controlled by a mechanical stopper.

4. The mechanism of claim 1, wherein movement of the pinch valve is controlled by the control unit.

5. The mechanism of claim 1, comprising a tube extending from an opening of the mechanism to a turbine wheel, wherein the tube leads water from the opening to the turbine wheel.

6. The mechanism of claim 5, wherein the tube extends through the pinch valve.

7. The mechanism of claim 1, comprising at least one sensor coupled to the control, wherein the at least one sensor is adapted to sense a presence or, lack thereof, for providing signals to the control unit in controlling the flow of the liquid.

8. The mechanism of claim 1, comprising a capacitor coupled to the hydrogenerator, wherein the capacitor is adapted to store energy produced by the hydrogenerator, and wherein the capacitor is adapted to power the control unit, the sensor and/or the valve, or a combination thereof.

9. The mechanism of claim 1, wherein the mechanism comprises an independent unit from a water system to which the mechanism is a coupled, and wherein the mechanism is separable from the water system.

10. The mechanism of claim 1, wherein the control unit has a user interface that enables adjustment of sensitivity of a sensor coupled thereto.

11. The mechanism of claim 1, wherein the control unit has user interface that enables sensing the fluid temperature via a colored light emitting diode (LED).

12. The mechanism of claim 1, wherein the control unit has user interface that enables manual operation of the valve.

13. The mechanism of claim 1, wherein the control unit has user interface that enables final positioning the pinch valve to regulate the fluid flow.

14. The mechanism of claim 1, wherein the control unit has user interface that enables sensing on the capacitor energy accumulated thereon, and wherein the control unit is further adapted to provide an indication, using a LED, on the amount of energy accumulated.

15. The mechanism of claim 1, wherein the control unit has user interface that enables sensing fluid within the mechanism.

16. A method of operating a fluid system, comprising:
converting fluid flow into electrical power using a hydroelectric generator disposed within a mechanism attachable to the water system;
regulating automatically fluid flow through the fluid system, using a control unit coupled to a motor coupled, wherein the motor is coupled to a pinch valve; and powering the control unit using the fluid flow of the fluid system.

17. The method of claim 16, wherein the fluid comprises water.

18. The method of claim 16, comprising controlling movement of the pinch valve using a mechanical stopper.

19. The method of claim 16, comprising sensing the presence of an object, using at least one sensor coupled to the control, for providing signals to the control unit in controlling the flow of the liquid.

20. The method of claim 16, wherein powering comprises drawing energy from a capacitor, coupled to the hydro electric generator for activating the control unit, at least one sensor, a fluid valve, or a combination thereof.

21. The method of claim 16, wherein the fluid system is attachable to a fluid outlet system, wherein the fluid system comprise an independent unit from the fluid outlet system, and wherein the fluid system is separable from the fluid outlet system.

22. The method of claim 16, wherein the fluid system comprises a mechanism comprising an independent unit from the fluid system, and wherein the mechanism has an adjustable connector that can be used by a user to direct the flow of water of a faucet and the attachment at various angles.
